(19) United States
(12) Patent Application Publication
(10) Pub. No.: US 2025/0297733 A1
(43) Pub. Date: Sep. 25, 2025

(54) TEMPERATURE CONTROL MEANS IN A WASTE HEAT BOILER

(71) Applicant: L'Air Liquide, Societe Anonyme pour l'Etude et l'Exploitation des Procedes Georges Claude, Paris (FR)

(72) Inventors: Dieter ULBER, Frankfurt am Main (DE); Frank Bruder, Frankfurt am Main (DE)

(21) Appl. No.: 19/086,657

(22) Filed: Mar. 21, 2025

(30) Foreign Application Priority Data
Mar. 25, 2024 (EP) 24165771

(51) Int. Cl. F22B 33/18; F22B 1/18; F22B 35/00

(52) U.S. Cl. CPC F22B 33/18; F22B 1/18; F22B 35/007

(57) ABSTRACT

Assembly comprising a reactor, a waste heat boiler, an actuator, a shaft, a shaft sealing element, an axial bearing and a temperature control means, wherein the waste heat boiler is connected to the reactor, wherein the shaft, the shaft sealing element and the axial bearing are arranged on a common axis, wherein the waste heat boiler has an opening through which the shaft is passed and which is sealed by the shaft sealing element, wherein the actuator is arranged outside the waste heat boiler, wherein the temperature control means is arranged inside the waste heat boiler, wherein the actuator is coupled to the shaft at a first end and wherein the actuator is designed to effect rotational drive of the shaft, wherein the temperature control means is coupled to the shaft at a second end and is designed to be adjusted by rotational motion of the shaft, wherein the axial bearing is designed to counteract a motion of the shaft in the direction of the first end of the shaft.

### CROSS-REFERENCE TO RELATED APPLICATIONS

This application claims the benefit of priority under 35 U.S.C. § 119 (a) and (b) to EP patent application No. EP 24165771.7, filed Mar. 25, 2024, the entire contents of which are incorporated herein by reference.

### BACKGROUND

The present invention relates to an assembly comprising a reactor in which a synthesis gas for methanol synthesis may especially be produced. The invention further relates to a process for operating this assembly.

### FIELD OF THE INVENTION

Processes for industrial production of synthesis gas for methanol synthesis by heterocatalytic reaction of gaseous or liquid carbonaceous feedstocks in suitable reactors are known. Synthesis gases may be various gas mixtures containing inter alia hydrogen and carbon oxides.

### RELATED ART

The process gases formed in reactors and composed predominantly of hydrogen, carbon oxides and steam and of unconverted hydrocarbons such as methane are subsequently cooled in waste heat boilers. Waste heat boilers and processes for cooling synthesis gas are known.

Control apparatuses for temperature control in waste heat boilers are also known. Here, a partially cooled process gas stream is passed through a large bypass pipe or a plurality of smaller bypass pipes. The cooled process gas stream is mixed with the partially cooled process gas stream from the bypass pipe or the bypass pipes to establish a desired offgas temperature of the waste heat boiler.

A control apparatus for an offgas temperature is important because a defective control means can result either in an excessively low offgas temperature or in a markedly elevated offgas temperature. An excessively low offgas temperature can adversely affect downstream components and processes for synthesis gas production which require a minimum temperature. An elevated offgas temperature can also adversely affect downstream components and processes for synthesis gas production. An elevated offgas temperature can further result in corrosion of the material in the waste heat boiler or subsequent components through “metal dusting”. This type of corrosion manifests in a decomposition of metal to metal powder. Metal dusting can occur especially in a carbon monoxide atmosphere.

It is also known that the shaft to the control apparatus expands due to higher temperatures during operation. The force required to move the shaft may therefore increase through frictional forces or the control means may become completely jammed.

The above-described problems from the prior art for methanol synthesis result from the design of the employed equipment. These problems thus similarly also occur when comparable equipment is utilized for another purpose, for example for production of another substance. Synthesis gas production for methanol synthesis is thus only to be considered as an example.

### SUMMARY OF THE INVENTION

It is an object of the present invention to be able to reliably regulate a temperature at an outlet of a waste heat boiler starting from the described prior art.

This object is achieved with the independent claims. Further advantageous embodiments are specified in the dependent claims. The features set out in the claims and in the description may be combined with one another in any technologically advantageous fashion.

The invention provides an assembly comprising a reactor, a waste heat boiler, an actuator, a shaft, a shaft sealing element, an axial bearing and a temperature control means. The waste heat boiler is connected to the reactor. The shaft, the shaft sealing element and the axial bearing are arranged on a common axis. The waste heat boiler has an opening through which the shaft is passed and which is sealed by the shaft sealing element. The actuator is arranged outside the waste heat boiler. The temperature control means is arranged inside the waste heat boiler. The actuator is coupled to the shaft at a first end and is designed to effect rotational drive of the shaft. The temperature control means is coupled to the shaft at a second end and is designed to be adjusted by rotational motion of the shaft. The axial bearing is designed to counteract a motion of the shaft in the direction of the first end of the shaft.

The assembly is preferably in the form of a reactor assembly with a temperature regulation. The assembly may be designed for performing a chemical reaction. The chemical reaction may be an exothermic reaction or an endothermic reaction. The assembly is particularly suitable for methanol synthesis gas production. However, the advantages described here can also be achieved for numerous other chemical reactions. The advantages are even achievable when the assembly is not utilized as a reactor assembly and when no chemical reaction occurs in the assembly. The assembly may generally also be designed as a heat exchanger.

The assembly comprises a waste heat boiler connected to a reactor.

The reactor may be designed to produce synthesis gas from a hydrocarbonaceous feedstock. It is preferable when feedstocks comprise gaseous or liquid hydrocarbons. The resulting heat may be at least partially removed in the waste heat boiler.

The reactor is preferably suitable for methanol synthesis gas production. The reactor may especially be suitable for steam reforming. The reactor may preferably be suitable for autothermal reforming. It is particularly preferable when the reactor is suitable for combined reforming, wherein combined reforming comprises a primary steam reforming and a downstream secondary autothermal reforming.

The reactor allows conversion of reactants to methanol synthesis gas. Methanol synthesis gas preferably comprises hydrogen, carbon monoxide and carbon dioxide as reaction products. Methanol synthesis gas more preferably comprises a mixture of hydrogen and carbon monoxide. Methanol synthesis gas particularly preferably comprises a mixture of hydrogen and carbon dioxide. The methanol synthesis gas may further contain inert gases. The methanol synthesis gas may especially contain methane as inert gas. The methanol synthesis gas preferably contains nitrogen as inert gas.

The reaction products may be passed from the reactor to the waste heat boiler as a process gas stream. The waste heat boiler can effect cooling of the process gas stream. To this end the waste heat boiler may comprise a plurality of heat transfer tubes through which the process gas stream may be passed. A coolant may be passed around the heat transfer tubes. While flowing through the heat transfer tubes the process gas stream can transfer the heat energy to the coolant via the tube wall of the heat transfer tubes. This can vaporize liquid coolant in the waste heat boiler so that the coolant in the waste heat boiler may be biphasic. The coolant is removable from the waste heat boiler via a coolant outlet. The coolant is preferably water.

Alternatively, heat energy may be transferred from the coolant to the process gas stream in the heat transfer tubes via the tube wall of the heat transfer tubes in the waste heat boiler.

The waste heat boiler is preferably an elongate hollow body. The waste heat boiler may be a cylindrical metal vessel which may be suitable for encompassing the heat transfer tubes. The waste heat boiler may have ports and connections to allow fluidic connection of the heat transfer tubes. From an inlet the process gas stream may be divided over the heat transfer tubes via an inlet chamber. Downstream of the heat transfer tubes the process gas stream is collected in an outlet chamber of the waste heat boiler and passed to the outlet of the waste heat boiler. The waste heat boiler may further comprise ports and connections so that in a shell space outside and between the heat transfer tubes the coolant or other medium may be introduced into and discharged from the waste heat boiler. The shell space may be fluidically connected.

The temperature control means is arranged inside the waste heat boiler. It is preferable when the temperature control means is at least partially arranged in the outlet chamber of the waste heat boiler. The temperature control means makes it possible to adjust the temperature at the outlet of the waste heat boiler. The manner in which this is done is largely immaterial to the advantages of the assembly described herein. The advantages are always achievable when the temperature control means is adjustable via a shaft as described below. There are accordingly numerous different options for configuring the temperature control means.

It is preferable when the temperature control means comprises a bypass tube, by means of which at least a portion of the process gas stream may be conducted separately from the heat transfer tubes. The bypass tube can project into the outlet chamber of the waste heat boiler. The temperature control means may also comprise a plurality of bypass tubes, by means of which at least a portion of the process gas stream may be conducted separately from the heat transfer tubes. The bypass tubes can project into the outlet chamber of the waste heat boiler.

It is preferable when the bypass tube is designed such that no direct heat exchange with the coolant occurs. The process gas in the form of an uncooled process gas stream may then be conducted in the bypass tube separately from the heat transfer tubes as a portion of the uncooled process gas stream.

It is particularly preferable when the bypass tube or plurality of bypass tubes is/are designed such that a coolant is passed around the bypass tube or plurality of bypass tubes. Upon passing through the bypass tube or the bypass tubes the initially uncooled process gas stream can transfer a portion of its thermal energy to the coolant via the tube wall of the bypass tube or the bypass tubes. The heat transfer from the bypass tube or the bypass tubes to the coolant may especially be lower than the heat transfer from the heat transfer tubes. The process gas in the form of a partially cooled process gas stream may then be passed into the bypass tube or the bypass tubes separately from the heat transfer tubes as a portion of the uncooled process gas stream. The internal diameter of the bypass tube or the bypass tubes is preferably greater than the diameter of the heat transfer tubes. The following may also be applied to a plurality of bypass tubes.

It is preferable when the temperature control means comprises a control flap or a throttle, a plunger or a throttle flap to control the process gas stream through the bypass tube.

The temperature control means makes it possible to adjust a flow of uncooled or partially cooled process gas through the bypass tube. By way of example the temperature control means can completely prevent flow through the bypass tube in a first setting, with the result that no uncooled or partially cooled process gas stream flows through the bypass tube. In a second setting the temperature control means can also impede flow through the bypass tube to a very small extent, with the result that a certain proportion of the uncooled or partially cooled process gas stream flows through the bypass tube. The temperature control means can also control the flow of the uncooled or partially cooled process gas stream to a setting between the first setting and the second setting. The control means can act directly on the uncooled or partially cooled process gas stream and/or on the cooled process gas stream. The uncooled or partially cooled process gas stream may be mixed with the process gas stream cooled by the heat transfer tubes in the outlet chamber upstream of the outlet from the waste heat boiler.

The temperature control means makes it possible to adjust the temperature of the process gas stream at the outlet of the waste heat boiler.

The temperature control means is coupled to the shaft at a second end and is designed to be adjusted by rotational motion of the shaft.

This can mean that for example a control flap of the temperature control means is rotated in the bypass tube such that the flow rate of the uncooled or partially cooled process gas stream can be regulated between the first and the second setting. However, it is not compulsory for the temperature control means to have a control flap. In order to achieve the advantages described herein it is sufficient for the temperature control means to be designed such that the temperature is controllable via the angle of rotation of the shaft.

It is preferable when the shaft and/or the temperature control means is supported, especially radially supported, and designed to absorb forces perpendicular to its axis. This has the advantage that frictional forces and fluidic forces of the process gas stream on the shaft and/or on the temperature control means can be absorbed without damaging the components.

It is preferable when the process gas stream at the outlet of the waste heat boiler has a temperature in the range from 200° C. to 650° C. during operation. The process gas stream at the outlet of the waste heat boiler more preferably has a temperature in the range from 300° C. to 550° C. during operation. The process gas stream at the outlet of the waste heat boiler particularly preferably has a temperature in the range from 400° C. to 500° C. during operation.

The waste heat boiler has an opening through which the shaft is passed and which is sealed by the shaft sealing element.

Sealing the waste heat boiler with respect to the environment may be achieved by applying radial forces to the shaft circumferentially from the shaft sealing element.

The shaft sealing element preferably serves to prevent gas from the pressurized waste heat boiler from escaping through the opening. Escaping gas may not only be toxic but can also form an explosive mixture together with air. The shaft sealing element may be safety-relevant and may ensure occupational health and safety.

The shaft, the shaft sealing element and the axial bearing are arranged on a common axis. This allows the sealing effect of the shaft sealing element to be maintained.

It is preferable when the shaft sealing element has a degree of freedom in the axial direction and a degree of freedom in the rotational direction about the axis.

The actuator is arranged outside the waste heat boiler. The actuator is coupled to the shaft at a first end and is designed to effect rotational drive of the shaft.

It is preferable when the actuator comprises a manual drive. The actuator more preferably comprises a pneumatic drive. The actuator particularly preferably comprises a pneumatic drive and a manual drive. To this end the actuator is preferably directly coupled to the shaft. The actuator is more preferably coupled to the shaft via a lever. The actuator is particularly preferably coupled to the shaft via a transmission.

An actuator arranged outside the waste heat boiler has the advantage that the shaft can be driven spaced apart from the waste heat boiler. This has the result of enhancing operator safety and preventing exposure of the actuator to the temperature and corrosion conditions of the process gas.

The axial bearing is designed to counteract a motion of the shaft in the direction of the first end of the shaft. It is preferable when the axial bearing has a degree of freedom in the rotational direction about the axis.

The axial bearing may have a first side and an opposite second side. It is preferable when the axial bearing is designed as a plain bearing. The axial bearing is more preferably designed as a rolling bearing with rolling elements between the first side and the second side. A force is transferable from the first side to the second side and vice versa via the rolling elements.

The axial bearing may be designed to counteract a movement of the shaft in the direction of the first end of the shaft, wherein a compressive force in the direction of the first end of the shaft may be brought about by a pressure difference between the waste heat boiler and the environment during operation.

The compressive force may be calculated from the pressure difference between the waste heat boiler and the environment multiplied by the area over which the pressure difference acts.

It is preferable when the process gas stream in the waste heat boiler exhibits a pressure difference of at least 20 bar relative to the environment. The process gas stream in the waste heat boiler more preferably exhibits a pressure difference of at least 40 bar relative to the environment.

The axial bearing may also be designed to counteract a motion of the shaft in the direction of the first end of the shaft due to a thermal expansion of the shaft.

In addition, the axial bearing may also be designed to counteract a motion of the shaft in the direction of the second end of the shaft.

The assembly allows for reliable control of a temperature of a process gas stream. To this end the assembly can ensure safe and reliable adjustability of the temperature control means during operation despite a compressive force arising from a pressure difference of the process gas stream in the waste heat boiler relative to the environment. This is achieved with the axial bearing.

It has been found according to the invention that in prior art solutions a pressure difference between the waste heat boiler and the environment exerts a compressive force on the shaft in the direction of the lower pressure of the environment. This outward force results in a significant frictional force which acts against a rotational motion of the shaft. This frictional force may be so great that the shaft is no longer rotatable. The axial bearing makes it possible to reduce or even completely avoid this effect.

In a preferred embodiment of the assembly the axial bearing is arranged inside the waste heat boiler and the axial bearing is arranged between the shaft sealing element and the temperature control means.

This embodiment has the advantage that during operation a compressive force due to a pressure difference between the waste heat boiler and the environment can be absorbed via the axial bearing. The arrangement of the axial bearing between the shaft sealing element and the temperature control means prevents an axial force acting on the shaft sealing element due to the pressure difference. It is preferable when only a negligible axial force, if any, from the shaft acts on the shaft sealing element. This ensures a more reliable sealing of the waste heat boiler with respect to the environment by the shaft sealing element.

This embodiment further has the advantage that the temperature control means can reliably control the temperature including in operation and the shaft does not jam during operation despite the axial compressive force on the shaft.

In a further preferred embodiment of the assembly the shaft sealing element and the axial bearing are arranged on the shaft spaced apart from one another.

This embodiment has the advantage that an axial force on the axial bearing is not transmitted into the shaft sealing element and the shaft sealing element does not dissipate any axial force.

In a further preferred embodiment of the assembly the shaft sealing element is arranged in the opening of the waste heat boiler. The shaft passes through the opening which is sealed by the shaft sealing element.

This embodiment has the advantage that the shaft sealing element is attached in a particularly space-saving manner.

The combination of this embodiment with the two preceding embodiments is preferred.

This has the particular advantage that the absorption of axial forces through the axial bearing and the sealing of the waste heat boiler by the shaft sealing element are particularly space-saving and reliable. The gas flow in the waste heat boiler thus suffers the least possible disruption and fewer flow dead zones in the waste heat boiler are formed.

In a further preferred embodiment of the assembly the axial bearing is arranged on a stop of the shaft on its first side and held by the waste heat boiler on its second side.

The advantage of this embodiment is that the axial bearing can transmit a force to the waste heat boiler in the direction of the first end of the shaft. This embodiment further has the advantage that the shaft does not transmit any force between the first end of the shaft and the axial bearing due to a pressure difference. This prevents or at least reduces an axial force on the shaft sealing element and the actuator. This makes it possible to avoid or at least reduce a frictional force opposing the rotational motion in the actuator which results from an axial force.

In a further preferred embodiment of the assembly the shaft sealing element is a stuffing box. The stuffing box comprises a stuffing box packing and a stuffing box flange, wherein a clearance between the shaft and a box is sealed by the stuffing box packing. The box is preferably connected to the waste heat boiler by a friction-locked connection. The box may also be part of the waste heat boiler.

The advantage of this embodiment is that the waste heat boiler is reliably sealed with respect to the environment but the shaft can continue to rotate.

In an alternative embodiment the axial bearing is mounted on the shaft between the actuator and the shaft sealing element. The axial bearing is arranged on a stop of the shaft on its first side and held by a holder means on its second side opposite the first side. The holder means is preferably arranged on the waste heat boiler.

The advantage of this embodiment is that the axial bearing is not in contact with the process gas.

In a further preferred embodiment of the assembly the assembly comprises a hydrocarbonaceous feedstock source. The feedstock source is connected to a reactant inlet of the reactor. The reactants may be supplied to the reactor via the reactant inlet.

In this embodiment the assembly is not only suitable for operation with hydrocarbonaceous reactants. On the contrary this use is mandatory in this embodiment in so far as the feedstock source is part of the assembly. Contemplated feedstock sources include any element which outputs hydrocarbons.

A further aspect of the invention provides a process for operating the assembly. Synthesis gas for methanol synthesis is produced in the reactor. A process gas stream from the reactor is passed into the waste heat boiler. A temperature of the process gas stream at an outlet of the waste heat boiler is regulated via the temperature control means by adjusting the temperature control means via the actuator.

The described advantages and features of the assembly are applicable and transferable to the process and vice versa. The assembly is preferably adapted for operation according to the described process.

A further aspect of the invention sets out the use. The assembly is used for producing a synthesis gas for methanol synthesis in the reactor. The synthesis gas produced preferably comprises hydrogen and/or carbon monoxide.

The synthesis gas may particularly preferably be converted to methanol.

The described advantages and features of the assembly and the process are applicable and transferable to the use and vice versa. The assembly is preferably designed to be used according to the use.

### BRIEF DESCRIPTION OF THE FIGURES

The invention will now be more particularly elucidated with reference to the figures. The figures show a particularly preferred exemplary embodiment which is not intended to limit the invention. The figures and the relative sizes shown therein are merely schematic. In the figures:

FIG. 1: shows a schematic view of an inventive assembly for methanol synthesis,

FIG. 2: shows a detailed view of an opening of the waste heat boiler of the assembly in FIG. 1.

### DETAILED DESCRIPTION OF THE INVENTION

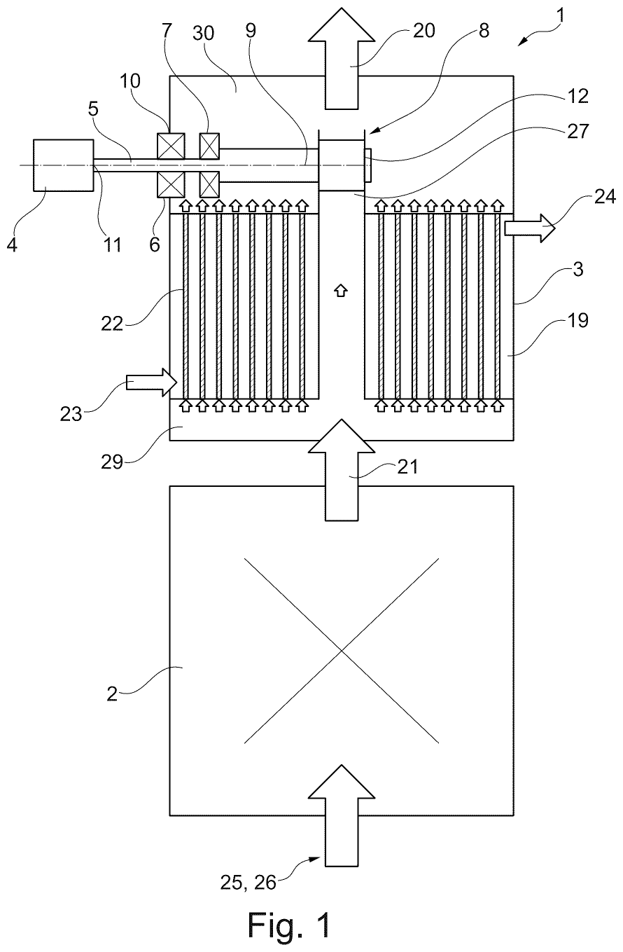

FIG. 1 shows a schematic view of an inventive assembly 1 for methanol synthesis. The assembly 1 comprises a reactor 2, a waste heat boiler 3, an actuator 4, a shaft 5, a shaft sealing element 6, an axial bearing 7 and a temperature control means 8. The assembly 1 further comprises a hydrocarbonaceous feedstock source 25 connected to a reactant inlet 26 of the reactor 2.

In assembly 1 hydrocarbonaceous feedstock is converted to synthesis gas in the reactor 2. Reactor 2 is suitable for combined reforming. The synthesis gas produced is passed into the waste heat boiler 3 together with unconverted feedstock as a process gas stream. A temperature of the process gas stream in an outlet chamber 30 of the waste heat boiler 3 is regulated via the temperature control means 8 by adjusting the temperature control means 8 via the actuator 4.

The reactor 2 is suitable for endothermic and exothermic reactions. The reactor 2 is designed for producing synthesis gas from the feedstock source 25.

The waste heat boiler 3 is connected to the reactor 2. To this end a process gas stream flows through an inlet 21 into an inlet chamber 29 of the waste heat boiler 3. This process gas stream contains synthesis gas.

The waste heat boiler 3 comprises heat transfer tubes 22. The waste heat boiler 3 has ports and connections to allow fluidic connection of the heat transfer tubes 22. From the inlet 21 the process gas stream is divided over the heat transfer tubes 22 via the inlet chamber 29. The waste heat boiler 3 further comprises ports and connections so that in a shell space 19 outside and between the heat transfer tubes 22 a coolant may be introduced into the waste heat boiler 3 via a coolant inlet 23 and discharged therefrom via a coolant outlet 24.

The process gas stream may be cooled in the waste heat boiler 3. While flowing through the heat transfer tubes 22 in the waste heat boiler 3 the process gas stream can transfer the heat energy to the coolant via the tube wall of the heat transfer tubes 22. This can vaporize liquid coolant in the waste heat boiler 3 so that the coolant in the waste heat boiler 3 is biphasic. The coolant is removed from the waste heat boiler 3 via the coolant outlet 24. The coolant employed is water.

The shaft 5, the shaft sealing element 6 and the axial bearing 7 are arranged on a common axis 9. The waste heat boiler 3 has an opening 10 through which the shaft 5 is passed and which is sealed by the shaft sealing element 6. The actuator 4 is arranged outside the waste heat boiler 3. By contrast, the temperature control means 8 is arranged inside the waste heat boiler 3. The actuator 4 is coupled to the shaft 5 at a first end 11. The actuator 4 is designed to effect rotational drive of the shaft 5. The temperature control means 8 is coupled to the shaft 5 at a second end 12 and is designed to be adjusted by rotational motion of the shaft 5.

The temperature control means 8 comprises a bypass tube 27, by means of which at least a portion of the partially cooled process gas stream may be conducted separately from the heat transfer tubes 22. The partially cooled process gas stream from the temperature control means 8 may be mixed with the process gas stream cooled by the heat transfer tubes 22 in the outlet chamber 30. The temperature control means 8 makes it possible to adjust the temperature of the process gas stream at the outlet 20 of the waste heat boiler 3.

The axial bearing 7 is designed to counteract a motion of the shaft 5 in the direction of the first end 11 of the shaft 5. The axial bearing 7 is arranged inside the waste heat boiler 3. The axial bearing 7 is arranged between the shaft sealing element 6 and the temperature control means 8.

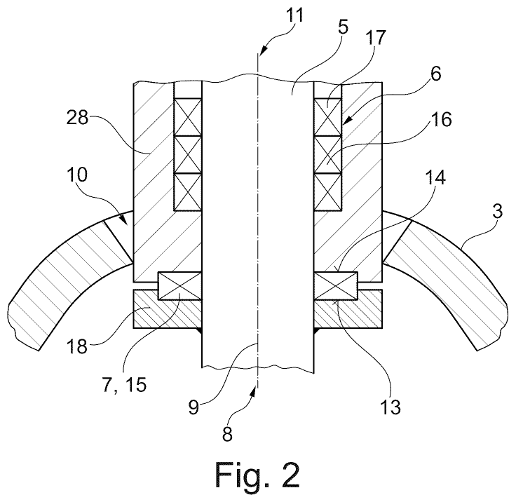

FIG. 2 shows a detailed view of an opening 10 of the waste heat boiler 3 of the assembly in FIG. 1. The shaft sealing element 6 and the axial bearing 7 are arranged on the shaft 5 spaced apart from one another. The shaft sealing element 6 is also arranged in the opening 10 of the waste heat boiler 3. The axial bearing 7 is arranged on a stop 18 of the shaft 5 on its first side 13. The shaft 5, the shaft sealing element 6 and the axial bearing 7 are arranged on the common axis 9. The axial bearing 7 is held on its second side 14 opposite the first side 13 by a box 28 on the waste heat boiler 3. The shaft sealing element 6 is designed as a stuffing box. The shaft sealing element 6 comprises a stuffing box packing 16 and a stuffing box flange 17, wherein a clearance between the shaft 5 and the box 28 is sealed by the stuffing box packing 16. The axial bearing 7 is designed to counteract a motion of the shaft 5 in the direction of the first end 11 of the shaft 5. The axial bearing 7 is arranged inside the waste heat boiler 3. The axial bearing 7 is arranged between the shaft sealing element 6 and the temperature control means 8. The axial bearing 7 is designed as a rolling bearing with rolling elements 15 between the first side 13 and the second side 14. A force is transferable from the first side 13 to the second side 14 and thus to the waste heat boiler 3 via the rolling elements 15.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

### LIST OF REFERENCE SIGNS

1 Assembly
2 Reactor
3 Waste heat boiler
4 Actuator
5 Shaft
6 Shaft sealing element
7 Axial bearing
8 Temperature control means
9 Axis
10 Opening
11 First end
12 Second end
13 First side
14 Second side
15 Rolling elements
16 Stuffing box packing
17 Stuffing box flange
18 Stop
19 Shell space
20 Outlet
21 Inlet
22 Heat transfer tubes
23 Coolant inlet
24 Coolant outlet
25 Feedstock source
26 Reactant inlet
27 Bypass tube
28 Box
29 Inlet chamber
30 Outlet chamber

1. An assembly comprising
a reactor,
a waste heat boiler,
an actuator,
a shaft,
a shaft sealing element,
an axial bearing and
a temperature control device,
wherein the waste heat boiler is connected to the reactor,
wherein the shaft, the shaft sealing element and the axial bearing are arranged on a common axis,
wherein the waste heat boiler has an opening through which the shaft is passed and which is sealed by the shaft sealing element,
wherein the actuator is arranged outside the waste heat boiler,
wherein the temperature control device is arranged inside the waste heat boiler,
wherein the actuator is coupled to the shaft at a first end,
wherein the actuator is designed to effect rotational drive of the shaft,
wherein the temperature control device is coupled to the shaft at a second end and is designed to be adjusted by rotational motion of the shaft,
wherein the axial bearing is designed to counteract a motion of the shaft in the direction of the first end of the shaft.

2. The assembly of claim 1, wherein the axial bearing is arranged inside the waste heat boiler and wherein the axial bearing is arranged between the shaft sealing element and the temperature control device.

3. The assembly of claim 1, wherein the axial bearing is arranged outside the waste heat boiler and wherein the axial bearing is arranged between the actuator and the shaft sealing element.

4. The assembly of claim 1, wherein the shaft sealing element and the axial bearing are arranged on the shaft spaced apart from one another.

5. The assembly of claim 1, wherein the shaft sealing element is arranged in the opening of the waste heat boiler.

6. The assembly of claim 1, wherein the axial bearing is arranged on a stop of the shaft on its first side and held by the waste heat boiler on its second side opposite the first side.

7. The assembly of claim 1, wherein the shaft sealing element is a stuffing box comprising a stuffing box packing and a stuffing box flange, wherein a clearance between the shaft and the box is sealed by the stuffing box packing.

8. The assembly of claim 1, comprising a hydrocarbon feedstock source connected to a reactant inlet of the reactor.

9. A process for operating an assembly according to claim 1, wherein a synthesis gas for methanol synthesis is produced in the reactor, wherein a process gas stream from the reactor is passed into the waste heat boiler, wherein a temperature of the process gas stream at an outlet of the waste heat boiler is regulated via the temperature control device by adjusting the temperature control device via the actuator.
